(19) United States
(12) Patent Application Publication
(10) Pub. No.: US 2019/0010423 A1
(43) Pub. Date: Jan. 10, 2019

(54) PACKAGED LIQUID FABRIC SOFTENER COMPOSITION HAVING IMPROVED STABILITY

(71) Applicant: The Procter & Gamble Company, Cincinnati, OH (US)

(72) Inventors: Pieter Jan Maria SAVEYN, Heusden (BE); Dries VAES, Houtvenne (BE); Laura ORLANDINI, Le Mont-sur-Lausanne (CH); Susana FERNANDEZ PRIETO, Benicassim (ES); Evelyne Johanna Lutgarde VANHECKE, Bachte-Maria-Leerne (BE)

(21) Appl. No.: 16/030,896

(22) Filed: Jul. 10, 2018

(30) Foreign Application Priority Data
Jul. 10, 2017 (EP) 17180487.5

(51) Int. Cl. C11D 3/00; B65D 1/02; B65D 41/26; B65D 85/00

(52) U.S. Cl. CPC C11D 3/0015; B65D 85/70; B65D 41/26; B65D 1/02

(57) ABSTRACT

The present invention relates to packaged product as well as the methods of using same. Such packaged product containing a liquid fabric softener composition wherein said liquid fabric softener composition comprises a quaternary ammonium ester softening active, dispersed perfume, and cellulose fibers. Such packaged liquid fabric softener compositions exhibit phase stability while also delivering the softening benefits and pleasant smell that are desired by consumers.

### FIELD OF THE INVENTION

The invention is directed to packaged liquid fabric softener compositions comprising cellulose fibers.

### BACKGROUND OF THE INVENTION

Fabric softener compositions provide benefits to treated fabrics, particularly in the last rinse phase of the laundry process, after the addition of the detergent composition. Such benefits include fabric softening, provided by the incorporation of fabric softener actives. To provide a rich appearance to the product and to avoid splashing upon dosing, rheology modifiers are typically added to thicken the composition. Cellulose fibers can be used as rheology modifier to thicken the liquid fabric softener composition while at the same time providing structure to maintain phase stability.

However, fabric softener compositions comprising cellulose fibers can still exhibit phase instabilities. Such phase instabilities of the liquid fabric softener composition can lead to cracking of the composition and compromise its structural integrity. This is especially problematic when the cellulose fibers containing fabric softener compositions are packaged in bottles, such as for example, which are made of polyethylene or polystyrene. With reference to FIG. 5, it is shown that cracks in the liquid fabric softener composition are visible when packaged in these bottles. The message that the cracks can connote is that possibly the product is of inferior quality, or there may be product degradation during shipment, storage or use, such as for example, when the composition is not homogenized prior to pouring the liquid fabric softener composition into a dosing cap. The undesirable consequences are reduced sales and/or increased packaging costs.

Hence, there is still a need for a packaged fabric softener composition comprising a fabric softening active and cellulose fibers having a rich appearance and improved phase stability. There is also a need for packaged fabric softener composition having sufficient properties which are consumer acceptable.

WO2008/076753 (A1) relates to surfactant systems comprising microfibrous cellulose to suspend particulates. WO2008/079693 (A1) relates to a cationic surfactant composition comprising microfibrous cellulose to suspend particulates. WO2011/056956 relates to aqueous compositions comprising surfactants, microfibrous cellulose, water, and alkaline earth metal ions. WO03085074 (A1) discloses a detergent composition comprising cationic surfactant, perfume, and microfibrous cellulose. WO2015/006635 relates to structured fabric care compositions comprising a fabric softener active and microfibrillated cellulose. The problem with the above-listed compositions is that they may still exhibit cracks when said compositions are contained in bottles.

### SUMMARY OF THE INVENTION

In a first aspect, the present invention is directed to a packaged product comprising: a packaging having a closed end and a peripheral wall extending from said closed end to an open neck, said peripheral wall having an interior surface comprising a material selected from the group consisting of polyethylene terephthalate (PET), polypropylene (PP), and mixtures thereof; and a fabric softening composition contained in said packaging and in contact with said material, wherein said fabric softening composition comprises a quaternary ammonium ester softening active, dispersed perfume, and cellulose fibers.

In another aspect, the present invention relates to the use of said packaging to improve the phase stability of the liquid fabric softener composition contained in said packaging.

In yet another aspect, the present invention relates to a method of treating a fabric comprising with the packaged liquid fabric softener composition.

One aim of the present invention is to provide a packaged liquid fabric softener compositions comprising quaternary ammonium ester fabric softening active, dispersed perfume, and cellulose fibers, where the compositions exhibit improved phase stability. Another aim of the present invention is to provide a packaged product comprising a composition as described herein, having sufficient properties, such as for example, phase stability, softness, a pleasant smell, and/or visual appearance, which are consumer acceptable.

These and other features of the present invention will become apparent to one skilled in the art upon review of the following detailed description when taken in conjunction with the appended claims.

### BRIEF DESCRIPTION OF THE DRAWINGS

While the specification concludes with claims particularly pointing out and distinctly claiming the invention, it is believed that the invention will be better understood from the following description of the accompanying figures in which like reference numerals identify like elements, and wherein:

FIG. 1 details the apparatus (see Methods).

FIG. 2 details the orifice component 5 of Apparatus A (see Methods).

FIG. 3 details the Apparatus B (see Methods).

FIG. 4 shows a photo of a packaged liquid fabric softener composition directly after filling a bottle made of polystyrene. The liquid fabric softener composition is visually homogeneous.

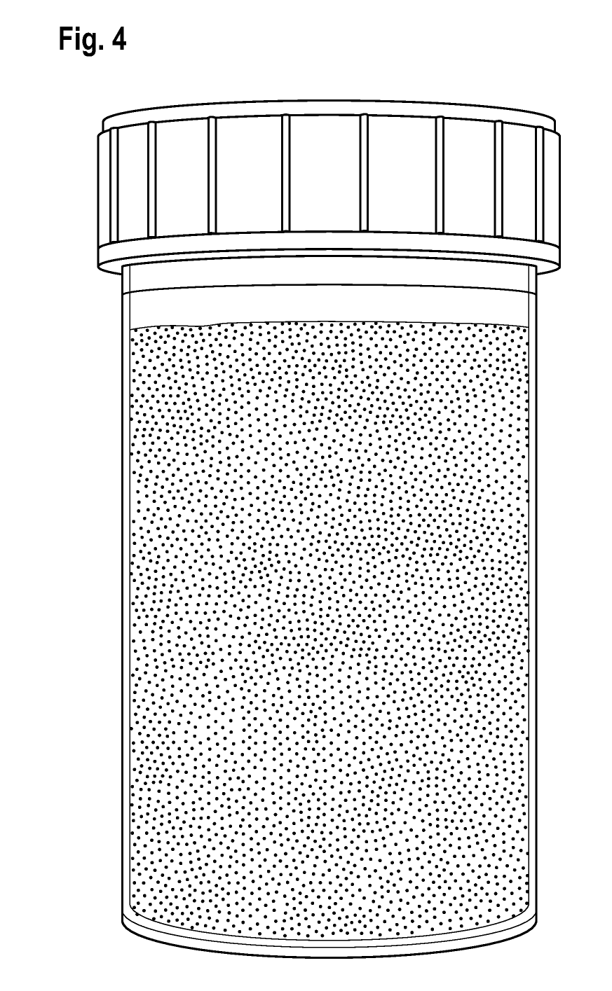

FIG. 5 shows a photo of the packaged liquid fabric softener composition of FIG. 4 after 3 days storage at 20° C. A clear crack was observed and highlighted with a white arrow.

FIG. 6 shows a photo of the packaged liquid fabric softener composition of the present invention which was still visually homogeneous after 2 weeks storage at 20° C. The packaging material comprised polyethylene terephthalate.

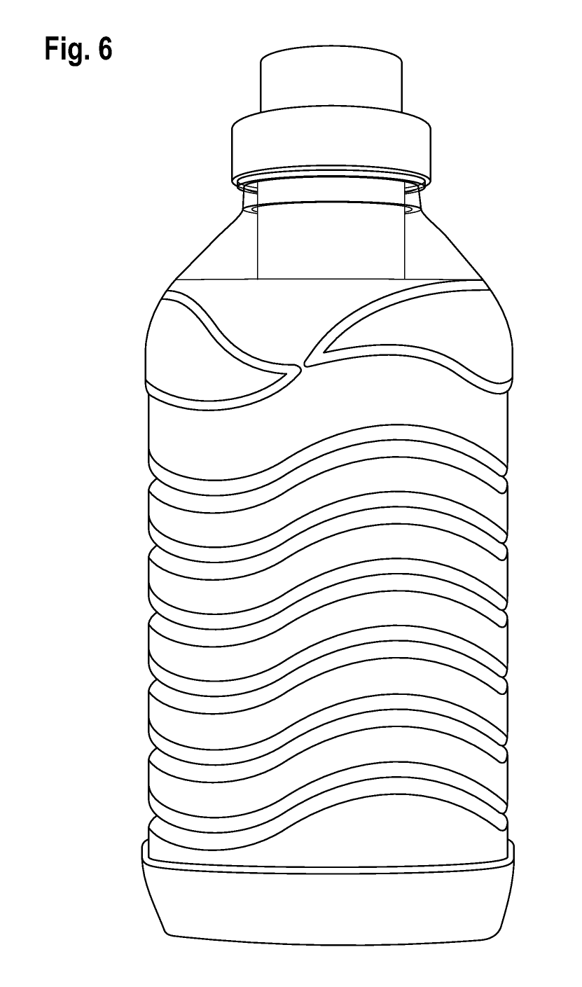

FIG. 7 shows a drawing of an embodiment of a packaging having a closed end and a peripheral wall extending from said closed end to an open neck, said peripheral wall having an interior surface, where said packaging is suitable to contain a liquid fabric softener composition.

### DETAILED DESCRIPTION OF THE INVENTION

### Definitions

As used herein, the articles including “a” and “an” when used in a claim, are understood to mean one or more of what is claimed or described.

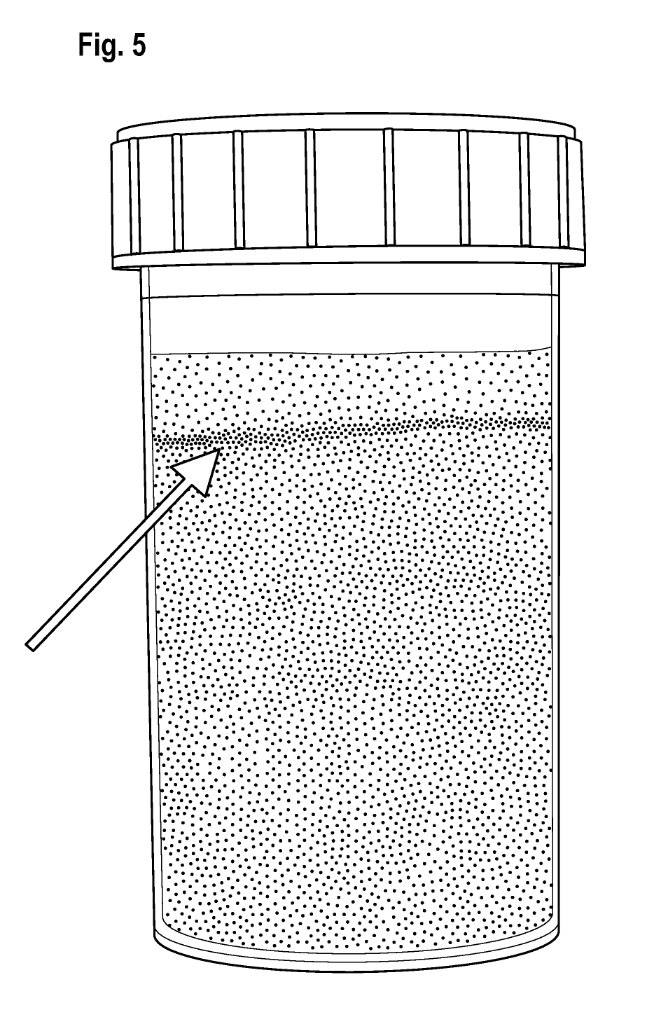

As used herein, the term “consumer acceptable” or “acceptable to consumers” refers to compositions that appear visually, preferably to the unaided eye, to lack visible cracks, distortions, or unevenness, that would cause the consumer to have concerns regarding the quality of the product contained in the packaging or the ability of the packaging to withstand shipping or storage conditions. See FIG. 5 for a non-limiting example of packaged product wherein the composition would be considered to have a consumer acceptable appearance.

As used herein, the terms “include”, “includes” and “including” are meant to be non-limiting.

Unless otherwise noted, all component or composition levels are in reference to the active portion of that component or composition, and are exclusive of impurities, for example, residual solvents or by-products, which may be present in commercially available sources of such components or compositions. For example, it is known that quaternary ammonium esters typically contain the following impurities: the monoester form of the quaternary ammonium ester, residual non-reacted fatty acid, and non-quaternized esteramines.

All percentages and ratios are calculated by weight unless otherwise indicated. All percentages and ratios are calculated based on the total composition unless otherwise indicated. All ratios are calculated as a weight/weight level of the active material, unless otherwise specified. All measurements are performed at 25° C. unless otherwise specified.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### The Liquid Fabric Softener Composition

It has been importantly found that the packaged liquid fabric softening composition in accordance with the present invention provides for a product having sufficient properties, such as for example, phase stability, softness, a pleasant smell, and/or visual appearance, which are consumer acceptable. Essentially, the solution is to package the liquid fabric softening composition in a bottle comprising a material selected from the group consisting of polyethylene terephthalate, polypropylene, and mixtures thereof.

As used herein, “liquid fabric softener composition” refers to any treatment composition comprising a liquid capable of softening fabrics, e.g., clothing in a domestic washing machine. The composition can include solids or gases in suitably subdivided form, but the overall composition excludes product forms which are non-liquid overall, such as tablets or granules. The liquid fabric softener composition preferably has a density in the range from 0.9 to 1.3 g·cm⁻³, excluding any solid additives but including any bubbles, if present.

Aqueous liquid fabric softening compositions are preferred. For such aqueous liquid fabric softener compositions, the water content can be present at a level of from 5% to 97%, preferably from 50% to 96%, more preferably from 70% to 95% by weight of the liquid fabric softener composition.

The pH of the neat fabric softener composition is typically acidic to improve hydrolytic stability of the quaternary ammonium ester softening active and may be from pH 2 to 6, preferably from pH 2 to 4.5, more preferably from 2 to 3.5 (see Methods).

To provide a rich appearance while maintaining pourability of the liquid fabric softener composition, the viscosity of the liquid fabric softener composition may be from 50 mPa·s to 1000 mPa·s, preferably from 70 mPa·s to 700 mPa·s, more preferably from 80 mPa·s to 500 mPa·s at a shear rate of 10 s⁻¹ (see Methods).

To maintain phase stability of the liquid fabric softener composition, the dynamic yield stress (see Methods) at 20° C. of the liquid fabric softener composition may be from 0.001 Pa to 1.0 Pa, preferably from 0.005 Pa to 0.8 Pa, more preferably from 0.010 Pa to 0.5 Pa. The absence of a sufficiently high dynamic yield stress may lead to phase instabilities such as particle creaming or settling in case the liquid fabric softener composition comprises suspended particles or encapsulated benefit agents. Higher dynamic yield stresses may lead to undesired air entrapment during filling of a packaging with the liquid fabric softener composition.

### Packaging

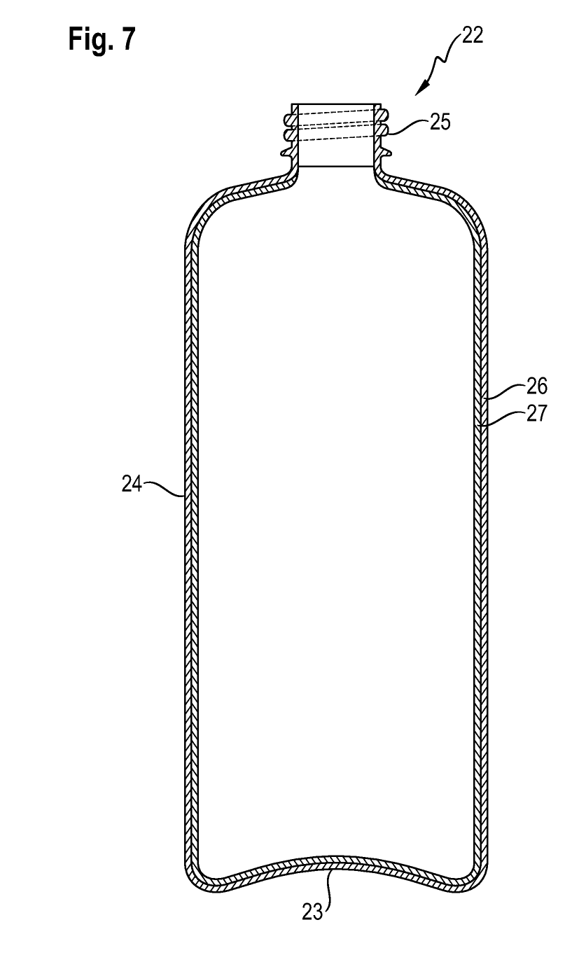

FIG. 7 illustrates a non-limiting example of a packaging suitable to contain a liquid fabric softener composition according to the present invention.

With reference to FIG. 7, the packaged product comprises a packaging (22) having a closed end (23) and a peripheral wall (24) extending from said closed end to an open neck (25), said peripheral wall having an exterior surface (26) and an interior surface (27) comprising a material selected from the group consisting of polyethylene terephthalate, polypropylene, and mixtures thereof. Preferably said material comprises polyethylene terephthalate. We have surprisingly found that such packaging improves the phase stability of liquid fabric softener compositions comprising quaternary ammonium ester softening active, cellulose fibers, and dispersed perfume.

The peripheral wall of the packaging in contact with the liquid fabric softener composition may have an average transmittance at a wavelength between 400 and 760 nm of at least 50%, preferably 60%, more preferably 70%, most preferably 80% (see Methods). A higher transmittance of the peripheral wall allows the consumer to see the actual liquid fabric softener composition when the packaged product is presented and provides a visual signal on how the product will perform upon use without the need to open the packaging.

Preferably, the packaging comprises a bottle and a dosing cap, wherein said dosing cap is removably attached to the bottle. Pouring of the liquid fabric softener composition into a dosing cap improves accurate dosing but also requires precise handling. As such the shear rates during the dosing process are low. Because the liquid fabric softener composition is a shear thinning product, its viscosity is high at low shear rates. Therefore, a dosing cap further improves the richness perception of the liquid fabric softener composition.

The packaging may comprise a label and/or sticker.

### Quaternary Ammonium Ester Softening Active

The liquid fabric softener composition of the present invention comprises quaternary ammonium ester softening active (Fabric Softening Active, “FSA”) at a level from 3% to 25% by weight of the composition, to provide softness to treated fabrics.

In preferred liquid fabric softener compositions, the quaternary ammonium ester softening active is present at a level of from 4% to 20%, more preferably from 5% to 17%, most preferably from 6% to 15% by weight of the composition. The level of quaternary ammonium ester softening active may depend on the desired concentration of the total softening active in the composition (i.e., diluted or concentrated composition). The level of quaternary ammonium ester softening active may also depend on the presence or absence of other softening active(s). Although higher FSA levels improve the softness benefits, they may also increase the risk of phase instability in the compositions. However, the present invention improves the phase stability of such fabric softener compositions, even with higher FSA levels.

Suitable quaternary ammonium ester softening actives include, but are not limited to, materials selected from the group consisting of monoester quats, diester quats, triester quats and mixtures thereof. Preferably, the level of monoester quat is from 2.0% to 40.0%, the level of diester quat is from 40.0% to 98.0%, the level of triester quat is from 0.0% to 25.0% by weight of total quaternary ammonium ester softening active.

Said quaternary ammonium ester softening active may comprise compounds of the following formula:

{R²₍₄₋ₘ₎—N+-[X—Y—R¹]ₘ}A-

wherein:
m is 1, 2 or 3 with proviso that the value of each m is identical;
each R¹ is independently hydrocarbyl, or branched hydrocarbyl group, preferably R¹ is linear, more preferably R¹ is partially unsaturated linear alkyl chain;
each R² is independently a C₁-C₃ alkyl or hydroxyalkyl group, preferably R² is selected from methyl, ethyl, propyl, hydroxyethyl, 2-hydroxypropyl, 1-methyl-2-hydroxyethyl, poly(C₂₋₃ alkoxy), polyethoxy, benzyl;
each X is independently —(CH₂)ₙ—, —CH₂—CH(CH₃)— or —CH(CH₃)—CH₂— and
each n is independently 1, 2, 3 or 4, preferably each n is 2;
each Y is independently —O—(O)C— or —C(O)—O—;
A- is independently selected from the group consisting of chloride, methyl sulfate, and ethyl sulfate, preferably A- is selected from the group consisting of chloride and methyl sulfate;
with the proviso that when Y is —O—(O)C—, the sum of carbons in each R¹ is from 13 to 21, preferably from 13 to 19. Preferably, X is —CH₂—CH(CH₃)— or —CH(CH₃)—CH₂— to further improve the hydrolytic stability of the quaternary ammonium ester softening active, and hence further improve the stability of the liquid fabric softener composition.

In preferred liquid fabric softener compositions, the iodine value of the parent fatty acid from which the quaternary ammonium fabric softening active is formed is from 0 to 100, more preferably from 10 to 60, even more preferably from 15 to 45.

Examples of suitable quaternary ammonium ester softening actives are commercially available from KAO Chemicals under the trade name Tetranyl® AT-1 and Tetranyl® AT-7590, from Evonik under the tradename Rewoquat® WE16 DPG, Rewoquat® WE18, Rewoquat® WE20, Rewoquat® WE28, and Rewoquat® 38 DPG, from Stepan under the tradename Stepantex® GA90, Stepantex® VR90, Stepantex® VK90, Stepantex® VA90, Stepantex® DC90, and Stepantex® VL90A.

These types of agents and general methods of making them are disclosed in U.S. Pat. No. 4,137,180.

### Cellulose Fibers:

The liquid fabric softener composition of the present invention comprises cellulose fibers at a level of from 0.01% to 5.0% by weight of the composition. Cellulose fibers thicken, and improve the phase stability of the liquid fabric softener composition. Moreover, cellulose fibers structure the liquid fabric softener compositions which enables suspension of particles such as benefit agent encapsulates to provide additional benefits to treated fabrics.

Preferably, the composition of the present invention comprises from 0.05% to 1.0%, more preferably from 0.1% to 0.75%, even more preferably from 0.12% to 0.5% of cellulose fibers by weight of the composition.

By cellulose fibers it is meant herein cellulose micro or nano fibrils. The cellulose fibers can be of bacterial or botanical origin, i.e. produced by fermentation or extracted from vegetables, plants, fruits or wood. Cellulose fiber sources may be selected from the group consisting of citrus peels, such as lemons, oranges and/or grapefruit; apples, bananas and/or pear; vegetables such as carrots, peas, potatoes and/or chicory; plants such as bamboo, jute, abaca, flax, cotton and/or sisal, cereals, and different wood sources such as spruces, eucalyptus and/or oak. Preferably, the cellulose fibers source is selected from the group consisting of wood or plants, in particular, spruce, eucalyptus, jute, and sisal.

The content of cellulose in the cellulose fibers will vary depending on the source and treatment applied for the extraction of the fibers, and will typically range from 15% to 100%, preferably above 30%, more preferably above 50%, and even more preferably above 80% of cellulose by weight of the cellulose fibers.

Such cellulose fibers may comprise pectin, hemicellulose, proteins, lignin and other impurities inherent to the cellulose based material source such as ash, metals, salts and combinations thereof. The cellulose fibers are preferably non-ionic. Such fibers are commercially available, for instance Citri-Fi 100FG from Fiberstar, Herbacel® Classic from Herbafood, and Exilva® from Borregaard.

To further improve the phase stability, the cellulose fibers may have an average diameter (see Methods) from 10 nm to 350 nm, preferably from 30 nm to 250 nm, more preferably from 50 nm to 200 nm.

### Non-Ionic Surfactants

The liquid fabric softener composition may comprise from 0.01% to 5.0%, preferably from 0.1% to 3.0%, more preferably from 0.5% to 2.0% of non-ionic surfactant based on the total fabric softener composition weight. Non-ionic surfactants further improve the viscosity stability when the liquid fabric softener composition has been exposed to freezing temperatures. Very high levels (e.g., 5% or above) of non-ionic surfactant may lead to phase instabilities.

In preferred liquid fabric softener compositions, the ratio by weight of quaternary ammonium ester softening active to non-ionic surfactant is from 3:1 to 500:1, preferably from 5:1 to 50:1, more preferably from 10:1 to 40:1.

In preferred liquid fabric softener compositions, the non-ionic surfactant is an alkoxylated non-ionic surfactant, preferably an ethoxylated non-ionic surfactant. Preferably the alkoxylated non-ionic surfactant has an average degree of alkoxylation of at least 3, preferably from 5 to 100, more preferably from 10 to 60.

Preferably the alkoxylated non-ionic surfactant is an ethoxylated non-ionic surfactant, more preferably an ethoxylated non-ionic surfactant having a hydrophobic lipophilic balance value of 8 to 18.

Examples of suitable non-ionic surfactants are commercially available from BASF under the tradename Lutensol® AT80 (ethoxylated alcohol with an average degree of ethoxylation of 80 from BASF), from Clariant under the tradename Genapol® T680 (ethoxylated alcohol with an average degree of ethoxylation of 68), from Sigma Aldrich under the tradename Tween® 20 (polysorbate with an average degree of ethoxylation of 20), from The Dow Chemical Company under the tradename Tergitol™ 15-S-30 (ethoxylated branched alcohol with an average degree of ethoxylation of 30), from Clariant under trade name Genapol® X407 (ethoxylated branched alcohol with an average degree of ethoxylation of 40).

### Dispersed Perfume

The liquid fabric softener composition of the present invention comprises dispersed perfume composition at a level of from 0.1% to 5.0% by weight of the composition. Dispersed perfume is typically added to provide the liquid fabric softener composition with a pleasant smell. Dispersed perfume increases the tendency of the liquid fabric softener composition to exhibit phase instabilities. However, the present invention improves the phase stability of packaged fabric softener compositions comprising dispersed perfume.

By dispersed perfume we herein mean a perfume composition that is freely dispersed in the liquid fabric softener composition and is not encapsulated. A perfume composition comprises one or more perfume raw materials. Perfume raw materials are the individual chemical compounds that are used to make a perfume composition. The choice of type and number of perfume raw materials is dependent upon the final desired scent. In the context of the present invention, any suitable perfume composition may be used. Those skilled in the art will recognize suitable compatible perfume raw materials for use in the perfume composition, and will know how to select combinations of ingredients to achieve desired scents.

Preferably, the level of dispersed perfume is at a level of from 0.3% to 4.0%, more preferably from 0.7% to 4.0%, even more preferably from 1.0% to 3.5% by total weight of the composition.

The perfume composition may comprise from 2.5% to 30%, preferably from 5% to 30% by total weight of perfume composition of perfume raw materials characterized by a log P lower than 3.0, and a boiling point lower than 250° C.

The perfume composition may comprise from 5% to 30%, preferably from 7% to 25% by total weight of perfume composition of perfume raw materials characterized by having a log P lower than 3.0 and a boiling point higher than 250° C. The perfume composition may comprise from 35% to 60%, preferably from 40% to 55% by total weight of perfume composition of perfume raw materials characterized by having a log P higher than 3.0 and a boiling point lower than 250° C. The perfume composition may comprise from 10% to 45%, preferably from 12% to 40% by total weight of perfume composition of perfume raw materials characterized by having a log P higher than 3.0 and a boiling point higher than 250° C.

### Particles

The liquid fabric softener composition of the present invention may also comprise particles. The liquid fabric softener composition may comprise, based on the total liquid fabric softener composition weight, from 0.02% to 10%, preferably from 0.1% to 4%, more preferably from 0.25% to 2.5% of particles. Said particles include beads, pearlescent agents, benefit agent encapsulates, and mixtures thereof.

### Encapsulated Benefit Agent:

The liquid fabric softener composition may comprise from 0.05% to 8%, preferably from 0.05% to 3%, more preferably from 0.05% to 2% by weight of encapsulated benefit agent. The benefit agent is selected from the group consisting of perfume composition, moisturizers, a heating or cooling agent, an insect/moth repellent, germ/mould/mildew control agents, softening agents, antistatic agents, anti-allergenic agents, UV protection agents, sun fade inhibitors, hueing dyes, enzymes and combinations thereof, color protection agents such as dye transfer inhibitors, bleach agents, and combinations thereof. Perfume compositions are preferred.

The benefit agent is encapsulated, for instance, as part of a core in one or more capsules. Such cores can comprise other materials, such as diluents, solvents and density balancing agents.

The capsules have a wall, which at least partially, preferably fully surrounds the benefit agent comprising core. The capsule wall material may be selected from the group consisting of melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof.

Preferably, the capsule wall comprises one or more wall material comprising melamine, polyacrylate based material and combinations thereof.

Said melamine wall material may be selected from the group consisting of melamine crosslinked with formaldehyde, melamine-dimethoxyethanol crosslinked with formaldehyde, and combinations thereof.

Said polyacrylate based material may be selected from the group consisting of polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer and combinations thereof.

Said polystyrene wall material may be selected from polyestyrene cross-linked with divinylbenzene.

Polyurea capsules can comprise a polyurea wall which is the reaction product of the polymerisation between at least one polyisocyanate comprising at least two isocyanate functional groups and at least one amine, preferably a polyfunctional amine as a cross-linking and a colloidal stabilizer.

Polyurethane capsules can comprise a polyureathane wall which is the reaction product of a polyfunctional isocyanate and a polyfunctional alcohol as a cross-linking agent and a colloidal stabilizer.

Suitable capsules can be obtained from Encapsys (Appleton, Wis., USA). The liquid fabric softener compositions may comprise combinations of different capsules, for example capsules having different wall materials and/or benefit agents.

As mentioned earlier, perfume compositions are the preferred encapsulated benefit agent. The perfume composition comprises perfume raw materials. The perfume composition can further comprise essential oils, malodour reducing agents, odour controlling agents and combinations thereof.

The perfume raw materials are typically present in an amount of from 10% to 95%, preferably from 20% to 90% by weight of the capsule.

The perfume composition may comprise from 2.5% to 30%, preferably from 5% to 30% by total weight of perfume composition of perfume raw materials characterized by a log P lower than 3.0, and a boiling point lower than 250° C.

The perfume composition may comprise from 5% to 30%, preferably from 7% to 25% by total weight of perfume composition of perfume raw materials characterized by having a log P lower than 3.0 and a boiling point higher than 250° C. The perfume composition may comprise from 35% to 60%, preferably from 40% to 55% by total weight of perfume composition of perfume raw materials characterized by having a log P higher than 3.0 and a boiling point lower than 250° C. The perfume composition may comprise from 10% to 45%, preferably from 12% to 40% by total weight of perfume composition of perfume raw materials characterized by having a log P higher than 3.0 and a boiling point higher than 250° C.

### Ratio of Encapsulated Benefit Agent to Dispersed Perfume Oil

The liquid fabric softener composition may comprise a ratio of perfume oil encapsulates to dispersed perfume oil by weight of from 1:1 to 1:40, preferably from 1:2 to 1:20, more preferably from 1:3 to 1:10 to improve the balance of the pleasant smell of treated fabrics at the wet and the dry stage.

### Additional Fabric Softening Active

The liquid fabric softener composition of the present invention may comprise from 0.01% to 10%, preferably from 0.1% to 10%, more preferably from 0.1% to 5% of additional fabric softening active. Suitable fabric softening actives, include, but are not limited to, materials selected from the group consisting of non-ester quaternary ammonium compounds, amines, fatty esters, sucrose esters, silicones, dispersible polyolefins, polysaccharides, fatty acids, softening oils, polymer latexes and combinations thereof.

### Non-Ester Quaternary Ammonium Compounds:

Suitable non-ester quaternary ammonium compounds comprise compounds of the formula:

[R₍₄₋ₘ₎—N⁺—R¹ₘ]X⁻

wherein each R comprises either hydrogen, a short chain C₁-C₆, in one aspect a C₁-C₃ alkyl or hydroxyalkyl group, for example methyl, ethyl, propyl, hydroxyethyl, poly(C₂₋₃ alkoxy), polyethoxy, benzyl, or mixtures thereof; each m is 1, 2 or 3 with the proviso that the value of each m is the same; the sum of carbons in each R¹ may be C₁₂-C₂₂, with each R¹ being a hydrocarbyl, or substituted hydrocarbyl group; and X⁻ may comprise any softener-compatible anion. The softener-compatible anion may comprise chloride, bromide, methylsulfate, ethylsulfate, sulfate, and nitrate. The softener-compatible anion may comprise chloride or methyl sulfate.

Non-limiting examples include dialkylenedimethylammonium salts such as dicanoladimethylammonium chloride, di(hard)tallowdimethylammonium chloride dicanoladimethylammonium methylsulfate, and mixtures thereof. Non-limiting examples of commercially available dialkylenedimethylammonium salts usable in the present invention is dioleyldimethylammonium chloride available from Witco Corporation under the trade name Adogen® 472 and dihardtallow dimethylammonium chloride available from Akzo Nobel under the tradename Arquad® 2HT75.

### Amines:

Suitable amines include but are not limited to, materials selected from the group consisting of amidoesteramines, amidoamines, imidazoline amines, alkyl amines, and combinations thereof. Suitable ester amines include but are not limited to, materials selected from the group consisting of monoester amines, diester amines, triester amines and combinations thereof. Suitable amidoamines include but are not limited to, materials selected from the group consisting of monoamido amines, diamido amines and combinations thereof. Suitable alkyl amines include but are not limited to, materials selected from the group consisting of mono alkylamines, dialkyl amines quats, trialkyl amines, and combinations thereof.

### Fatty Acid:

The liquid fabric softener composition may comprise a fatty acid, such as a free fatty acid as fabric softening active. The term “fatty acid” is used herein in the broadest sense to include unprotonated or protonated forms of a fatty acid. One skilled in the art will readily appreciate that the pH of an aqueous composition will dictate, in part, whether a fatty acid is protonated or unprotonated. The fatty acid may be in its unprotonated, or salt form, together with a counter ion, such as, but not limited to, calcium, magnesium, sodium, potassium, and the like. The term “free fatty acid” means a fatty acid that is not bound to another chemical moiety (covalently or otherwise).

The fatty acid may include those containing from 12 to 25, from 13 to 22, or even from 16 to 20, total carbon atoms, with the fatty moiety containing from 10 to 22, from 12 to 18, or even from 14 (mid-cut) to 18 carbon atoms.

The fatty acids may be derived from (1) an animal fat, and/or a partially hydrogenated animal fat, such as beef tallow, lard, etc.; (2) a vegetable oil, and/or a partially hydrogenated vegetable oil such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, castor oil, etc.; (3) processed and/or bodied oils, such as linseed oil or tung oil via thermal, pressure, alkali-isomerization and catalytic treatments; (4) combinations thereof, to yield saturated (e.g. stearic acid), unsaturated (e.g. oleic acid), polyunsaturated (linoleic acid), branched (e.g. isostearic acid) or cyclic (e.g. saturated or unsaturated α-disubstituted cyclopentyl or cyclohexyl derivatives of polyunsaturated acids) fatty acids.

Mixtures of fatty acids from different fat sources can be used.

The cis/trans ratio for the unsaturated fatty acids may be important, with the cis/trans ratio (of the C18:1 material) being from at least 1:1, at least 3:1, from 4:1 or even from 9:1 or higher.

Branched fatty acids such as isostearic acid are also suitable since they may be more stable with respect to oxidation and the resulting degradation of color and odor quality.

The fatty acid may have an iodine value from 0 to 140, from 50 to 120 or even from 85 to 105.

### Polysaccharides:

The liquid fabric softener composition may comprise a polysaccharide as a fabric softening active, such as cationic starch. Suitable cationic starches for use in the present compositions are commercially-available from Cerestar under the trade name C*BOND® and from National Starch and Chemical Company under the trade name CATO® 2A.

### Sucrose Esters:

The liquid fabric softener composition may comprise a sucrose esters as a fabric softening active. Sucrose esters are typically derived from sucrose and fatty acids. Sucrose ester is composed of a sucrose moiety having one or more of its hydroxyl groups esterified.

Sucrose is a disaccharide having the following formula:

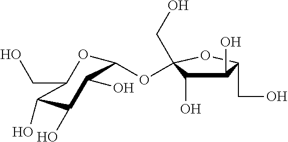

Alternatively, the sucrose molecule can be represented by the formula: M(OH)₈, wherein M is the disaccharide backbone and there are total of 8 hydroxyl groups in the molecule.

Thus, sucrose esters can be represented by the following formula:

M(OH)₈₋ₓ(OC(O)R¹)ₓ

wherein x is the number of hydroxyl groups that are esterified, whereas (8-x) is the hydroxyl groups that remain unchanged; x is an integer selected from 1 to 8, alternatively from 2 to 8, alternatively from 3 to 8, or from 4 to 8; and R¹ moieties are independently selected from C₁-C₂₂ alkyl or C₁-C₃₀ alkoxy, linear or branched, cyclic or acyclic, saturated or unsaturated, substituted or unsubstituted.

The R¹ moieties may comprise linear alkyl or alkoxy moieties having independently selected and varying chain length. For example, R¹ may comprise a mixture of linear alkyl or alkoxy moieties wherein greater than 20% of the linear chains are C₁₈, alternatively greater than 50% of the linear chains are C₁₈, alternatively greater than 80% of the linear chains are C₁₈.

The R¹ moieties may comprise a mixture of saturate and unsaturated alkyl or alkoxy moieties. The iodine value (IV) of the sucrose esters suitable for use herein ranges from 1 to 150, or from 2 to 100, or from 5 to 85. The R¹ moieties may be hydrogenated to reduce the degree of unsaturation. In the case where a higher IV is preferred, such as from 40 to 95, then oleic acid and fatty acids derived from soybean oil and canola oil are suitable starting materials.

The unsaturated R¹ moieties may comprise a mixture of “cis” and “trans” forms the unsaturated sites. The “cis”/“trans” ratios may range from 1:1 to 50:1, or from 2:1 to 40:1, or from 3:1 to 30:1, or from 4:1 to 20:1.

### Dispersible Polyolefins and Latexes:

Generally, all dispersible polyolefins that provide fabric softening benefits can be used as fabric softening active in the present invention. The polyolefins can be in the form of waxes, emulsions, dispersions or suspensions.

The polyolefin may be chosen from a polyethylene, polypropylene, or combinations thereof. The polyolefin may be at least partially modified to contain various functional groups, such as carboxyl, alkylamide, sulfonic acid or amide groups. The polyolefin may be at least partially carboxyl modified or, in other words, oxidized.

Non-limiting examples of fabric softening active include dispersible polyethylene and polymer latexes. These agents can be in the form of emulsions, latexes, dispersions, suspensions, and the like. In one aspect, they are in the form of an emulsion or a latex. Dispersible polyethylenes and polymer latexes can have a wide range of particle size diameters (χ₅₀) including but not limited to from 1 nm to 100 μm; alternatively from 10 nm to 10 μm. As such, the particle sizes of dispersible polyethylenes and polymer latexes are generally, but without limitation, smaller than silicones or other fatty oils.

Generally, any surfactant suitable for making polymer emulsions or emulsion polymerizations of polymer latexes can be used as emulsifiers for polymer emulsions and latexes used as fabric softeners active in the present invention. Suitable surfactants include anionic, cationic, and nonionic surfactants, and combinations thereof. In one aspect, such surfactants are nonionic and/or anionic surfactants. In one aspect, the ratio of surfactant to polymer in the fabric softening active is 1:5, respectively.

### Silicone:

The liquid fabric softener composition may comprise a silicone as fabric softening active. Useful silicones can be any silicone comprising compound. The silicone polymer may be selected from the group consisting of cyclic silicones, polydimethylsiloxanes, aminosilicones, cationic silicones, silicone polyethers, silicone resins, silicone urethanes, and combinations thereof. The silicone may be a polydialkylsilicone, alternatively a polydimethyl silicone (polydimethyl siloxane or “PDMS”), or a derivative thereof. The silicone may be chosen from an aminofunctional silicone, amino-polyether silicone, alkyloxylated silicone, cationic silicone, ethoxylated silicone, propoxylated silicone, ethoxylated/propoxylated silicone, quaternary silicone, or combinations thereof.

### Further Perfume Delivery Technologies

The liquid fabric softener composition may comprise one or more perfume delivery technologies that stabilize and enhance the deposition and release of perfume ingredients from treated substrate. Such perfume delivery technologies can be used to increase the longevity of perfume release from the treated substrate. Perfume delivery technologies, methods of making certain perfume delivery technologies and the uses of such perfume delivery technologies are disclosed in US 2007/0275866 A1.

The liquid fabric softener composition may comprise from 0.001% to 20%, or from 0.01% to 10%, or from 0.05% to 5%, or even from 0.1% to 0.5% by weight of the perfume delivery technology. Said perfume delivery technologies may be selected from the group consisting of: pro-perfumes, cyclodextrins, starch encapsulated accord, zeolite and inorganic carrier, and combinations thereof.

Amine Reaction Product (ARP): For purposes of the present application, ARP is a subclass or species of pro-perfumes. One may also use “reactive” polymeric amines in which the amine functionality is pre-reacted with one or more PRMs to form an amine reaction product (ARP). Typically the reactive amines are primary and/or secondary amines, and may be part of a polymer or a monomer (non-polymer). Such ARPs may also be mixed with additional PRMs to provide benefits of polymer-assisted delivery and/or amine-assisted delivery. Non-limiting examples of polymeric amines include polymers based on polyalkylimines, such as polyethyleneimine (PEI), or polyvinylamine (PVAm). Non-limiting examples of monomeric (non-polymeric) amines include hydroxyl amines, such as 2-aminoethanol and its alkyl substituted derivatives, and aromatic amines such as anthranilates. The ARPs may be premixed with perfume or added separately in leave-on or rinse-off applications. A material that contains a heteroatom other than nitrogen, for example oxygen, sulfur, phosphorus or selenium, may be used as an alternative to amine compounds. The aforementioned alternative compounds can be used in combinations with amine compounds. A single molecule may comprise an amine moiety and one or more of the alternative heteroatom moieties, for example, thiols, and phosphines. The benefit may include improved delivery of perfume as well as controlled perfume release.

### Deposition Aid

The liquid fabric softener composition may comprise, based on the total liquid fabric softener composition weight, from 0.0001% to 3%, preferably from 0.0005% to 2%, more preferably from 0.001% to 1% of a deposition aid. The deposition aid may be a cationic or amphoteric polymer. The cationic polymer may comprise a cationic acrylate. Cationic polymers in general and their method of manufacture are known in the literature. Deposition aids can be added concomitantly with particles or directly in the liquid fabric softener composition. Preferably, the deposition aid is selected from the group consisting of polyvinylformamide, partially hydroxylated polyvinylformamide, polyvinylamine, polyethylene imine, ethoxylated polyethylene imine, polyvinylalcohol, polyacrylates, and combinations thereof.

The weight-average molecular weight of the polymer may be from 500 to 5,000,000 Dalton or from 1,000 to 2,000,000 Dalton or from 2,500 to 1,500,000 Dalton, as determined by size exclusion chromatography relative to polyethyleneoxide standards using Refractive Index (RI) detection. In one aspect, the weight-average molecular weight of the cationic polymer may be from 500 to 37,500 Dalton.

### Dyes and Pigments

The liquid fabric softener composition may comprise adjunct ingredients suitable for use in the instant compositions and may be desirably incorporated in certain aspects of the invention, for example to improve the aesthetics of the composition as is the case with pigments and dyes. Moreover, liquid fabric softener compositions comprising unsaturated quaternary ammonium ester softening actives are subject to some degree of UV light and/or oxidation which increases the risk on yellowing of the liquid fabric softener composition as well as yellowing of treated fabrics. However, especially in the presence of a dye phase instabilities become more apparent. The liquid fabric softener composition may comprise from 0.0001% to 0.1%, preferably from 0.001% to 0.05% of a dye by weight of the composition. Suitable dyes are selected from the list comprising bis-azo dyes, tris-azo dyes, acid dyes, azine dyes, hydrophobic dyes, methane basic dyes, anthraquinone basic dyes, and dye conjugates formed by binding acid or basic dyes to polymers.

### Methods

The following assays set forth must be used in order that the invention described and claimed herein may be more fully understood. For each method applied to a fabric softener composition, a visually homogeneous sample is used. In case the liquid fabric softener composition is visually not homogeneous, the entire fabric softener composition is homogenized in a way to avoid air entrapment, prior to sampling to ensure representative sampling.

### Method 1—Method of Determining Transmittance of Peripheral Wall of Packaging

The transmission of the peripheral wall of the packaging in contact with the liquid fabric softener composition is determined by emptying the package containing the liquid fabric softener composition. The empty package is further rinsed with water and ethanol to remove liquid fabric softener residues adhering to the wall of the packaging. Prior to the transmission measurement, any label is removed from the peripheral wall of the packaging. A piece of about 2×2 cm is cut from the package and transmission is measured using a visible-range high-performance color measurement spectrophotometer with an integrating sphere and capable of measuring both reflectance and transmission, such as UltraScan VIS Spectrophotometer from HunterLab.

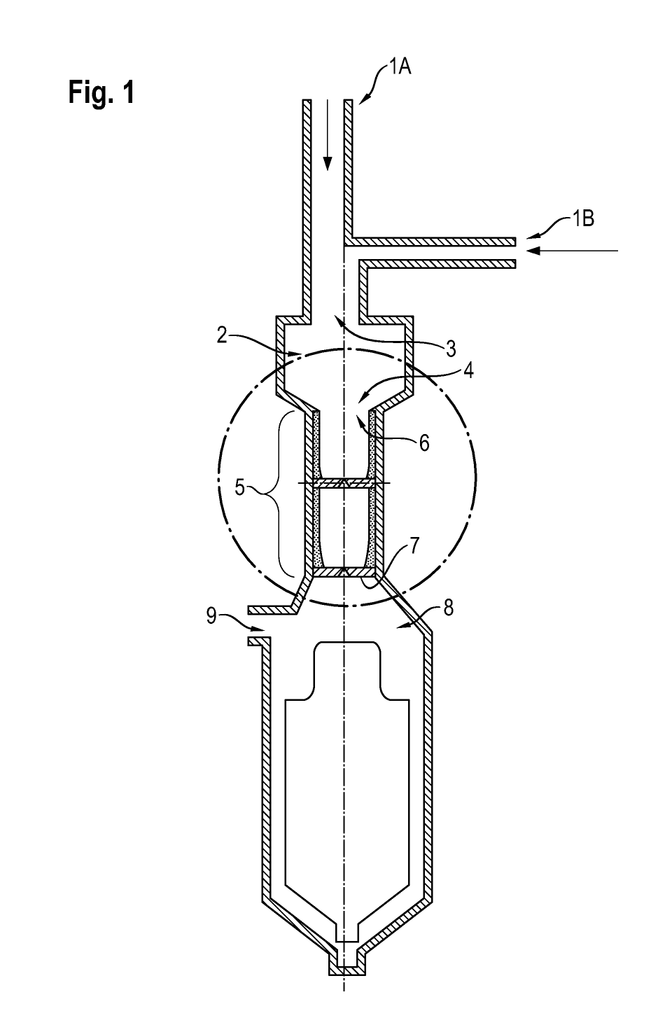

The instrument is used in total transmission mode to quantify the absorbance of the package sample in the broad visible spectrum (see FIG. 1). Transmission spectra is recorded for each package sample at wavelength range between 360 nm and 780 nm.

Data below 410 nm wavelength is discarded since some packages contain UV filters embedded that blocks transmission in this area.

Transmission percentage is averaged between 410 nm and 760 nm using following formula:

$$Avg = \frac{{\sum }_{i = 410}^{780} {T}_{i}}{{\sum }_{i = 410}^{780} i}$$

Wherein i is the number of wavelengths at which transmission is measured and Tᵢ the transmission measured at each wavelength.

A transmission of 100% means completely transparent, while values above 70% transmission are considered translucent.

### Method 2—Method of Determining pH of a Fabric Softener Composition

The pH is measured on the neat fabric softener composition, using a Sartorius PT-10P pH meter with gel-filled probe (such as the Toledo probe, part number 52 000 100), calibrated according to the instructions manual.

### Method 3—Method for Determining Viscosity and Dynamic Yield Stress

Viscosity and dynamic yield stress are measured using a controlled stress rheometer (such as an HAAKE™ MARS™ from Thermo Scientific, or equivalent), using a 60 mm parallel plate and a gap size of 500 microns at 20° C. The viscosity and dynamic yield stress are obtained by measuring quasi steady state shear stress as a function of shear rate in the range starting from 10 s⁻¹ to 10⁻⁴ s⁻¹, taking 25 points logarithmically distributed over the shear rate range. Quasi-steady state is defined as the shear stress value once variation of shear stress over time is less than 3%, after at least 30 seconds and a maximum of 60 seconds at a given shear rate. Variation of shear stress over time is continuously evaluated by comparison of the average shear stress measured over periods of 3 seconds. If after 60 seconds measurement at a certain shear rate, the shear stress value varies more than 3%, the final shear stress measurement is defined as the quasi state value for calculation purposes. The viscosity of the liquid fabric softener composition is defined as the measured shear stress divided by the applied shear rate of 10 s⁻¹.

Shear stress data is then fitted using least squares method in logarithmic space as a function of shear rate following a Herschel-Bulkley model:

τ=τ₀±k\dot{γ}ⁿ

wherein τ is the measured equilibrium quasi steady state shear stress at each applied shear rate \dot{γ}, τ₀ is the fitted dynamic yield stress. k and n are fitting parameters.

### Method 4—Method of Measuring Iodine Value of a Quaternary Ammonium Ester Fabric Softening Active

The iodine value (“IV”) of a quaternary ammonium ester fabric softening active is the iodine value of the parent fatty acid from which the fabric softening active is formed, and is defined as the number of grams of iodine which react with 100 grams of parent fatty acid from which the fabric softening active is formed.

First, the quaternary ammonium ester fabric softening active is hydrolysed according to the following protocol: 25 g of fabric softener composition is mixed with 50 mL of water and 0.3 mL of sodium hydroxide (50% activity). This mixture is boiled for at least an hour on a hotplate while avoiding that the mixture dries out. After an hour, the mixture is allowed to cool down and the pH is adjusted to neutral (pH between 6 and 8) with sulfuric acid 25% using pH strips or a calibrated pH electrode.

Next the fatty acid is extracted from the mixture via acidified liquid-liquid extraction with hexane or petroleum ether: the sample mixture is diluted with water/ethanol (1:1) to 160 mL in an extraction cylinder, 5 grams of sodium chloride, 0.3 mL of sulfuric acid (25% activity) and 50 mL of hexane are added. The cylinder is stoppered and shaken for at least 1 minute. Next, the cylinder is left to rest until 2 layers are formed. The top layer containing the fatty acid in hexane is transferred to another recipient. The hexane is then evaporated using a hotplate leaving behind the extracted fatty acid.

Next, the iodine value of the parent fatty acid from which the fabric softening active is formed is determined following ISO3961:2013. The method for calculating the iodine value of a parent fatty acid comprises dissolving a prescribed amount (from 0.1-3 g) into 15 mL of chloroform. The dissolved parent fatty acid is then reacted with 25 mL of iodine monochloride in acetic acid solution (0.1M). To this, 20 mL of 10% potassium iodide solution and 150 mL deionised water is added. After the addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acid enables the iodine value to be calculated.

### Method 5—Method of Measuring Fatty Acid Chain Length Distribution

The fatty acid chain length distribution of the quaternary ammonium ester fabric softening active refers to the chain length distribution of the parent fatty acid from which the fabric softening active is formed. It can be measured on the quaternary ammonium ester softening active or on the fatty acid extracted from the liquid fabric softener composition as described in the method to determine the iodine value of a quaternary ammonium ester fabric softening active. The fatty acid chain length distribution is measured by dissolving 0.2 g of the quaternary ammonium ester softening active or extracted fatty acid in 3 mL of 2-butanol, 3 glass beads are added and the sample is vortexed at high speed for 4 minutes. An aliquot of this extract is then transferred into a 2 mL gas chromatography vial, which is then injected into the gas chromatogram inlet (250° C.) of the gas chromatograph (Agilent GC6890N) and the resultant bi-products are separated on a DB-5 ms column (30 m×250 μm×1.0 μm, 2.0 mL/min). These bi-products are identified using a mass-spectrometer (Agilent MSD5973N, Chemstation Software version E.02.02) and the peak areas of the corresponding fatty acid chain lengths are measured. The fatty acid chain length distribution is determined by the relative ratios of the peak areas corresponding to each fatty acid chain length of interest as compared to the sum of all peaks corresponding to all fatty acid chain lengths.

### Method 6—Method for Determining Average Cellulose Fiber Diameter

The average cellulose fiber diameter can be determined directly from the cellulose fiber raw material or from the liquid fabric softener composition comprising cellulose fibers.

A) Cellulose fibers raw material: A cellulose fibers sample is prepared by adding 1% dry matter of cellulose fibers to water and activating it with a high pressure homogenizer (PANDA from GEA, 350 bars, 10 passes). The obtained sample is analyzed.

B) Fabric softener composition comprising cellulose fibers: The liquid fabric softener composition sample is centrifuged at 4,000 rpm for 10 minutes using a 5804 centrifuge from Eppendorf, in order to remove potential particles to avoid interference in the measurement of the fiber size. The clarified fabric softener composition is then decanted as the supernatant. The cellulose fibers present in the liquid fabric softener composition (supernatant) are redispersed in ethanol using an Ultra-Turrax® device from IKA, T25 S 25 N-25 G-ST, at a speed of 21 000 rpm for 10 minutes. Then, sample is centrifuged at 4 000 rpm for 10 minutes using a 5804 centrifuge from Eppendorf and supernatant is removed. Remaining cellulose fibers at the bottom are analyzed. The process is repeated as many times as needed to have enough amount for the analysis.

Average cellulose fiber diameter is analysed using Atomic force microscopy (AFM). A 0.02% cellulose fiber dispersion in demineralized water is prepared, and a drop of this dispersion is deposited onto freshly cleaved mica (highest grade V1 Mica, 15×15 mm—TED PELLA, INC., or equivalent). The sample is then allowed to dry in an oven at 40° C.

The mica sheet is mounted in an AFM (Nanosurf Flex AFM, ST Instruments or equivalent) and imaged in air under ambient conditions using a Si cantilever in dynamic mode with dynamic mode tip (ACTA-50—APPNANO or equivalent). The image dimensions are 20 micron by 20 micron, and 256 points per line are captured.

The AFM image is opened using suitable AFM data analysis software (such as Mountainsmap SPM 7.3, ST Instruments, or equivalent). Each image is leveled line by line. One or more profiles are extracted crossing perpendicularly one or multiple fibers avoiding bundles of fibers, and from each profile, a distance measurement is performed to obtain the diameter of the fibers. Ten diameter measurements are performed per picture counting each fiber only once. Three sets of measurements (sample preparation, AFM measurement and image analysis) are made. The arithmetic mean of all fibers measured in all images is the Average Cellulose Fiber Diameter.

### Method 7—Method of Determining Partition Coefficient

The partition coefficient, P, is the ratio of concentrations of a compound in a mixture of two immiscible phases at equilibrium, in this case n-Octanol/Water. The value of the log of the n-Octanol/Water Partition Coefficient (log P) can be measured experimentally using well known means, such as the “shake-flask” method, measuring the distribution of the solute by UV/VIS spectroscopy (for example, as described in “The Measurement of Partition Coefficients”, Molecular Informatics, Volume 7, Issue 3, 1988, Pages 133-144, by Dearden J C, Bresnan). Alternatively, the log P can be computed for each PRM in the perfume mixture being tested. The log P of an individual PRM is preferably calculated using the Consensus log P Computational Model, version 14.02 (Linux) available from Advanced Chemistry Development Inc. (ACD/Labs) (Toronto, Canada) to provide the unitless log P value. The ACD/Labs' Consensus log P Computational Model is part of the ACD/Labs model suite.

### Processes of Making the Liquid Fabric Softener Composition of the Invention

The compositions of the present invention can be formulated into any suitable form and prepared by any process chosen by the formulator, non-limiting examples of which are described in Applicant's examples and in US 2013/0109612 A1 which is incorporated herein by reference.

The compositions disclosed herein may be prepared by combining the components thereof in any convenient order and by mixing, e.g., agitating, the resulting component combination to form a phase stable fabric care composition. A fluid matrix may be formed containing at least a major proportion, or even substantially all, of the fluid components with the fluid components being thoroughly admixed by imparting shear agitation to this liquid combination. For example, rapid stirring with a mechanical stirrer may be employed.

The liquid fabric softener compositions described herein can also be made as follows:
Taking an apparatus A (see FIG. 1) comprising:

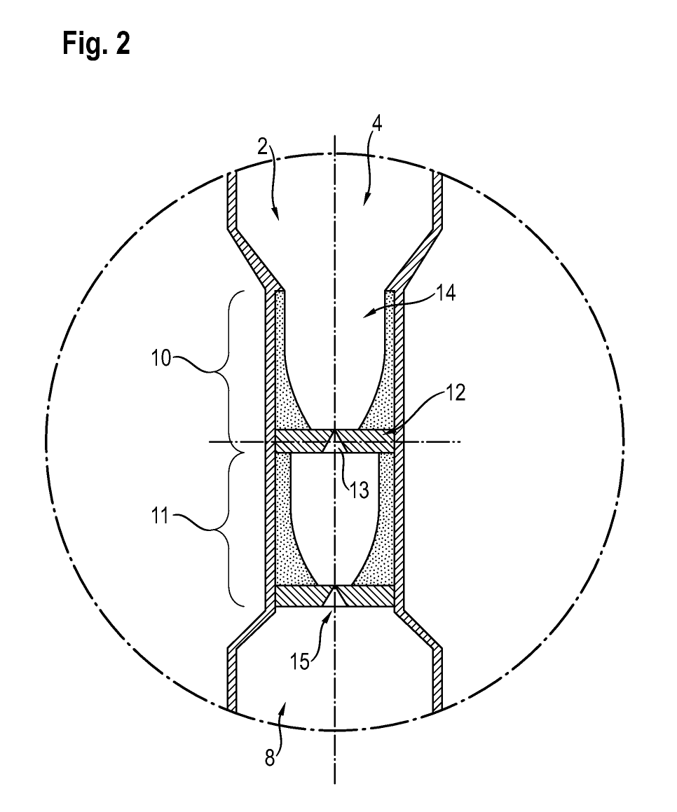

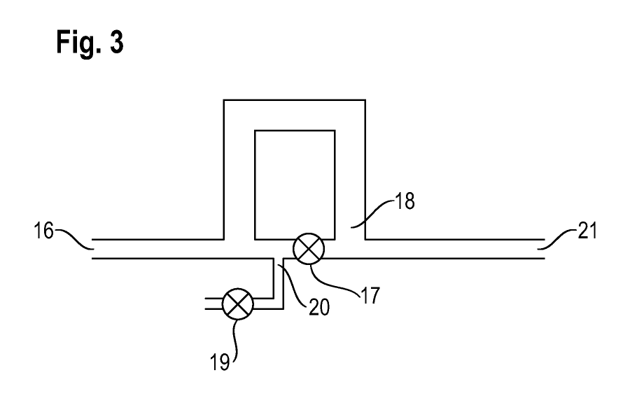

at least a first inlet (1A) and a second inlet (1B); a pre-mixing chamber (2), the pre-mixing chamber (2) having an upstream end (3) and a downstream end 4, the upstream end (3) of the pre-mixing chamber (2) being in liquid communication with the first inlet 1A and the second inlet 1B; an orifice component (5), the orifice component (5) having an upstream end (6) and a downstream end (7), the upstream end of the orifice component (6) being in liquid communication with the downstream end (4) of the pre-mixing chamber (2), wherein the orifice component (5) is configured to spray liquid in a jet and produce shear and/or turbulence in the liquid; a secondary mixing chamber (8), the secondary mixing chamber (8) being in liquid communication with the downstream end (7) of the orifice component (5); at least one outlet (9) in liquid communication with the secondary mixing chamber (8) for discharge of liquid following the production of shear and/or turbulence in the liquid, the inlet 1A, pre-mixing chamber (2), the orifice component (5) and secondary mixing chamber (8) are linear and in straight line with each other, at least one outlet (9) being located at the downstream end of the secondary mixing chamber (8); the orifice component (5) comprising at least one orifice unit, a specific example, as shown in FIG. 2, is that the orifice component (5) comprises two orifice units (10) and (11) arranged in series to one another and each orifice unit comprises an orifice plate (12) comprising at least one orifice (13), an orifice chamber (14) located upstream from the orifice plate (12) and in liquid communication with the orifice plate (12); and wherein neighboring orifice plates are distinct from each other;
connecting one or more suitable liquid pumping devices to the first inlet 1A and to the second inlet 1B;
pumping a second liquid composition into the first inlet 1A, and, pumping a liquid fabric softener active composition into the second inlet 1B, wherein the operating pressure of the apparatus is from 2.5 bar to 50 bar, from 3.0 bar to 20 or from 3.5 bar to 10 bar the operating pressure being the pressure of the liquid as measured in the first inlet 1A near to inlet 1B. The operating pressure at the outlet of apparatus A needs to be high enough to prevent cavitation in the orifice;
allowing the liquid fabric softener active and the second liquid composition to pass through the apparatus A at a desired flow rate, wherein as they pass through the apparatus A, they are dispersed one into the other, herein, defined as a liquid fabric softener intermediate.
passing said liquid fabric softener intermediate from Apparatus A's outlet, to Apparatus B's (FIG. 3) inlet (16) to subject the liquid fabric softener intermediate to additional shear and/or turbulence for a period of time within Apparatus B.
circulating said liquid fabric softener intermediate within apparatus B with a circulation Loop pump (17) at a Circulation Loop (18) Flow Rate equal to or greater than said inlet liquid fabric softener intermediate flow rate in said Circulation Loop System. A tank, with or without a recirculation loop, or a long conduit may also be employed to deliver the desired shear and/or turbulence for the desired time.
adding by means of a pump (19), piping and in-line fluid injector (20), an adjunct fluid, in one aspect, but not limited to a dilute salt solution, into Apparatus B to mix with the liquid fabric softener intermediate
allowing the liquid fabric softener composition with the desired microstructure to exit Apparatus B (21) at a rate equal to the inlet flow rate into Apparatus B.
passing said liquid fabric softener composition exiting Apparatus B outlet through a heat exchanger to be cooled to ambient temperature, if necessary.
discharging the resultant liquid fabric softener composition produced out of the outlet of the process.

The process comprises introducing, in the form of separate streams, the fabric softener active in a liquid form and a second liquid composition comprising other components of a fabric softener composition into the pre-mixing chamber 2 of Apparatus A so that the liquids pass through the orifice component (5). The fabric softener active in a liquid form and the second liquid composition pass through the orifice component (5) under pressure. The fabric softener active in liquid form and the second liquid composition can be at the same or different operating pressures. The orifice component (5) is configured, either alone, or in combination with some other component, to mix the liquid fabric softener active and the second liquid composition and/or produce shear and/or turbulence in each liquid, or the mixture of the liquids.

The liquids can be supplied to the apparatus A and B in any suitable manner including, but not limited to through the use of pumps and motors powering the same. The pumps can supply the liquids to the apparatus A under the desired operating pressure. In one embodiment, an ‘8 frame block-style manifold’ is used with a 781 type Plunger pump available from CAT pumps (1681 94th Lane NE, Minneapolis, Minn. 55449).

The operating pressure of conventional shear and/or turbulence apparatuses is typically between 2 bar and 490 bar. The operating pressure is the pressure of the liquid in the inlet 1A near inlet 1B. The operating pressure is provided by the pumps.

The operating pressure of Apparatus A is measured using a Cerphant T PTP35 pressure switch with a RVS membrane, manufactured by Endress Hauser (Endress+Hauser Instruments, International AG, Kaegenstrasse 2, CH-4153, Reinach). The switch is connected with the inlet 1A near inlet 1B using a conventional thread connection (male thread in the pre-mix chamber housing, female thread on the Cerphant T PTP35 pressure switch).

The operating pressure of Apparatus A may be lower than conventional shear and/or turbulence processes, yet the same degree of liquid mixing is achievable as seen with processes using conventional apparatuses. Also, at the same operating pressures, the process of the present invention results in better mixing than is seen with conventional shear and/orturbulence processes.

As the fabric softener active and the second liquid composition flow through the Apparatus A, they pass through the orifices (13) and (15) of the orifice component (5). As they do, they exit the orifice(s) (13) and/or (15) in the form of a jet. This jet produces shear and/or turbulence in the fabric softener active and the second liquid composition, thus dispersing them one in the other to form a uniform mixture.

In conventional shear and/or turbulence processes, the fact that the liquids are forced through the orifice(s) (13) and/or (15) under high pressure causes them to mix. This same degree of mixing is achievable at lower pressures when the liquids are forced through a series of orifices, rather than one at a high pressure. Also, at equivalent pressures, the process of the present invention results in better liquid mixing than shear and/or turbulence processes, due to the fact that the liquids are now forced through a series of orifices.

A given volume of liquid can have any suitable residence time and/or residence time distribution within the apparatus A. Some suitable residence times include, but are not limited to from 1 microsecond to 1 second, or more. The liquid(s) can flow at any suitable flow rate through the apparatus A. Suitable flow rates range from 1 to 1 500 L/min, or more, or any narrower range of flow rates falling within such range including, but not limited to from 5 to 1 000 L/min.

For Apparatus B Circulating Loop System example, one may find it convenient to characterize the circulation flow by a Circulation Loop Flow Rate Ratio which is equal to the Circulation Flow Rate divided by the Inlet Flow Rate. Said Circulation Loop Flow Rate Ratio for producing the desired fabric softener composition microstructure can be from 1 to 100, from 1 to 50, and even from 1 to 20. The fluid flow in the circulation loop imparts shear and turbulence to the liquid fabric softener to transform the liquid fabric softener intermediate into a desired dispersion microstructure.

The duration of time said liquid fabric softener intermediate spends in said Apparatus B may be quantified by a Residence Time equal to the total volume of said Circulation Loop System divided by said fabric softener intermediate inlet flow rate. Said Circulation Loop Residence Time for producing desirable liquid fabric softener composition microstructures may be from 0.1 seconds to 10 minutes, from 1 second to 1 minute, or from 2 seconds to 30 seconds. It is desirable to minimize the residence time distribution.

Shear and/or turbulence imparted to said liquid fabric softener intermediate may be quantified by estimating the total kinetic energy per unit fluid volume. The kinetic energy per unit volume imparted in the Circulation Loop System to the fabric softener intermediate in Apparatus B may be from 10 to 1 000 000 g·cm⁻¹·s⁻², from 50 to 500 000 g·cm⁻¹·s⁻², or from 100 to 100 000 g·cm⁻¹·s⁻². The liquid(s) flowing through Apparatus B can flow at any suitable flow rate. Suitable inlet and outlet flow rates range from 1 to 1 500 L/min, or more, or any narrower range of flow rates falling within such range including, but not limited to from 5 to 1 000 L/min. Suitable Circulation Flow Rates range from 1 L/min to 20 000 L/min or more, or any narrower range of flow rates falling within such range including but not limited to from 5 to 10 000 L/min. Apparatus A is ideally operated at the same time as Apparatus B to create a continuous process. The liquid fabric softener intermediate created in Apparatus A may also be stored in a suitable vessel and processed through apparatus B at a later time.

### Examples

The following examples and descriptions further describe preferred aspects of the present invention. These examples are given solely for the purpose of illustration and are not to be construed as limitations of the present invention as many variations thereof are possible without departing from the spirit and scope.

A fabric softener composition was prepared by first preparing a dispersion of the quaternary ammonium ester softener active (“FSA”) using Apparatus A and B in a continuous fluid making process with 3 orifices. Heated FSA at 81° C. and heated deionized water at 65° C. containing adjunct materials NaHEDP chelant, HCl, formic acid, and the preservative were fed using positive displacement pumps, through Apparatus A, and through Apparatus B, a circulation loop fitted with a centrifugal pump. The liquid fabric softener composition was immediately cooled to 25° C. with a plate heat exchanger. The total flow rate was 3.1 Kg/min; pressure at Apparatus A Inlet was 5 bar; pressure at Apparatus A Outlet was 2.5 bar; Apparatus B Circulation Loop Flow rate Ratio 8.4; Apparatus B Kinetic Energy 18000 g·cm⁻¹·s⁻²; Apparatus B Residence Time 14 s; Apparatus B Outlet pressure was 3 bar.

The liquid fabric softener composition was finished by adding the remaining ingredients as provided in Table 1 below using a Ytron-Y high speed mixer operated at 20 Hz for 15-20 mins. The cellulose fibers were added to the finished fabric softener composition by adding a 3% cellulose fiber dispersion in a last step to the liquid fabric softener composition using a Silverson Homogenizer LSM, operating at 4,500 rpm for 5 mins, to achieve a homogeneous dispersion. The preparation of the 3% premix comprising the cellulose fibers was obtained by mixing the 10% aqueous cellulose fiber paste as obtained from the supplier in the non-thickened liquid fabric softener composition with an IKA Ultra-Turrax® high shear mixer for 10 mins at 21,500 rpm.

TABLE 1
Inventive Liquid Fabric Softener Composition

| | Amount (Weight %) |
|---|---|
| Deionized water | balance |
| NaHEDP | 0.007 |
| Formic acid | 0.043 |
| HCl | 0.019 |
| Preservative ^{a} | 0.021 |
| FSA^{b} | 6.7 |
| Antifoam ^{c} | 0.097 |
| CaCl₂ | 0.0095 |
| Dye | 0.01 |
| Antibacterial agent ^{d} | 0.49 |
| Dispersed Perfume | 2.35 |
| Cellulose fibers^{e} | 0.15 |
| Total | 100% |
| Viscosity at 10 s⁻¹ [mPa · s] | 81 |
| Dynamic yield stress [Pa] | 0.05 |

^{a} Proxel GXL, 20% aqueous dipropylene glycol solution of 1,2-benzisothiazolin-3-one, supplied by Lonza. This material is part of the dispersion that is made and is not added at another point in the process.
^{b}Mixture of bis-(2-hydroxypropyl)-dimethylammonium methylsulfate fatty acid ester, (2-hydroxypropyl)-(1-methyl-2hydroxyethyl)-dimethylammonium methylsulfate fatty acid ester, bis-(1-methyl-2hydroxyethyl)-dimethylammonium methylsulfate fatty acid ester. The iodine value of the parent fatty acid of this material is between 18 and 22. The material as obtained from Evonik contains impurities in the form of free fatty acid and the monoester.
^{c} MP10 ®, supplied by Dow Corning, 8% activity.
^{d} Bardac ™ 2250J, 50% solution of didecyldimethylammonium chloride, supplied by Lonza.
^{e}Exilva ®, microfibrous cellulose, expressed as 100% dry matter, supplied by Borregaard as an aqueous 10% microfibrous cellulose dispersion. The average diameter of the fibers was 87 nm.

To assess phase stability of packed liquid fabric softener composition, packaging bottles with different properties were selected and described in Table 2.

TABLE 2
Properties of Different Packaging Bottles

| | | | Bottle | Wall |
|---|---|---|---|---|
| | | | volume | thickness |
| | Bottle material | Production process | [mL] | [mm] |
| A | high density | Extrusion blow | 594 | 0.7 |
| | polyethylene (HDPE) | molding | | |
| B | low density | Extrusion blow | 2070 | 1.3 |
| | polyethylene (LDPE) | molding | | |
| C | Polystyrene (PS) | 2-step injection | 200 | 1.2 |
| | | stretch blow molding | | |
| D | polyethylene | 2-step injection | 816 | 0.4 |
| | terephthalate (PET) | stretch blow molding | | |
| E | polyethylene | 2-step injection | 550 | 0.5 |
| | terephthalate (PET) | stretch blow molding | | |
| F | Polypropylene (PP) | 2-step injection | 1000 | 0.8 |
| | | stretch blow molding | | |
| G | Polypropylene (PP) | Extrusion blow | 825 | 0.9 |
| | | molding | | |

The liquid fabric softener composition of Table 1 was packaged in different bottles of Table 2, and the phase stability of the composition was evaluated. The bottles were stored at 20° C. for 4 weeks, and visual observation of the appearance of the compositions was recorded and summarized in Table 3. The criteria for “good quality” meant that the composition did not appear to be cracked, distorted or uneven. Specific attention was paid to the absence or presence of watery cracks visible in the liquid fabric softener composition packed in different bottles.

TABLE 3
Phase Stability of Packaged Fabric Softener Compositions

| | | Filling | | |
|---|---|---|---|---|
| | | level | Headspace | Visual |
| Example | Bottle | [mL] | [%] | appearance |
| Ex. 1* | A | 502 | 16 | cracks |
| Ex. 2* | B | 1825 | 12 | cracks |
| Ex. 3* | C | 150 | 22 | cracks |
| Ex. 4 | D | 690 | 15 | good quality |
| Ex. 5 | E | 504 | 8 | good quality |
| Ex. 6 | F | 885 | 12 | good quality |
| Ex. 7 | G | 740 | 10 | good quality |

*Comparative examples are marked with asterisk.

Comparative examples 1, 2, and 3 all showed phase instabilities in the form of watery cracks within 4 weeks storage at 20° C. No link of the presence of such watery cracks with the bottle volume, filling volume, headspace or wall thickness could be established. Without wishing to be bound by theory, the cracks are believed to be caused by syneresis of the thickened, structured fabric softener composition in contact with the interior surface of the bottle and propagated in the composition. Surprisingly, Applicant has found that examples 4, 5, 6, and 7 according to the present invention do not show such phase instability with the bottles made from polyethylene terephthalate or Polypropylene.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A packaged product comprising
a packaging having a closed end and a peripheral wall extending from said closed end to an open neck, said peripheral wall having an interior surface comprising a material selected from the group consisting of polyethylene terephthalate, polypropylene, and mixtures thereof; and
a liquid fabric softener composition contained in said packaging and in contact with said material, wherein said fabric softening composition comprises a quaternary ammonium ester softening active at a level of from about 3% to about 25%, dispersed perfume at a level of from about 0.1% to about 5.0%, and cellulose fibers at a level of from about 0.01% to about 5.0%, by weight of the composition.

2. The packaged product according to claim 1, wherein the peripheral wall of the packaging in contact with the liquid fabric softener having an average transmittance at a wavelength between about 400 and about 760 nm of at least about 50%.

3. The packaged product according to claim 1, wherein the quaternary ammonium ester softening active is present at a level of from about 4% to about 20%, by weight of the composition.

4. The packaged product according to claim 1, wherein the quaternary ammonium ester softening active has the following formula:
{R²₍₄₋ₘ₎—N+-[X—Y—R¹]ₘ}A-
wherein:
m is 1, 2 or 3 with proviso that the value of each m is identical;
each R¹ is independently hydrocarbyl, or branched hydrocarbyl group, preferably R¹ is linear, more preferably R¹ is partially unsaturated linear alkyl chain;
each R² is independently a C₁-C₃ alkyl or hydroxyalkyl group, preferably R² is selected from methyl, ethyl, propyl, hydroxyethyl, 2-hydroxypropyl, 1-methyl-2-hydroxyethyl, poly(C₂₋₃ alkoxy), polyethoxy, benzyl;
each X is independently —(CH₂)ₙ—, —CH₂—CH(CH₃)— or —CH(CH₃)—CH₂— and
each n is independently 1, 2, 3 or 4, preferably each n is 2;
each Y is independently —O—(O)C— or —C(O)—O—;
A- is independently selected from the group consisting of chloride, methyl sulfate, and ethyl sulfate, preferably A- is selected from the group consisting of chloride and methyl sulfate, more preferably A- is methyl sulfate;
with the proviso that when Y is —O—(O)C—, the sum of carbons in each R¹ is from about 13 to about 21.

5. The packaged product according to claim 1, wherein the cellulose fiber is present at a level of from about 0.05% to about 1.0% by weight of the composition.

6. The packaged product according to claim 1, wherein said packaging comprises a bottle and a cap wherein said cap is removably attached to the bottle.

7. The packaged product according to claim 1, wherein the cellulose fiber is microfibrous cellulose, microfibrous cellulose derived from: bacterial or botanical origin, preferably from wood or plants, in particular, spruce, eucalyptus, jute, and sisal, more preferably from wood or jute.

8. The packaged product according to claim 1, wherein the cellulose fibers have an average diameter from about 10 nm to about 350 nm.

9. The packaged product according to claim 1, wherein the liquid fabric softener composition has a viscosity from about 50 mPa·s to about 1000 mPa·s, measured at a shear rate of 10 s⁻¹ at about 25° C.

10. The packaged product according to claim 1, wherein the liquid fabric softener composition has a yield stress from about 0.005 Pa to about 2.0 Pa, measured at about 25° C.

11. The packaged product according to claim 1 wherein the dispersed perfume is present at a level of from about 0.3% to about 4% by weight of the composition.

12. The packaged product according to claim 1, wherein the liquid fabric softener composition further comprises a dye.

13. The packaged product according to claim 1, wherein the liquid fabric softener composition further comprises from about 0.05% to about 10% by total weight of the composition of encapsulated benefit agent, said encapsulated benefit agent is encapsulated in capsules wherein said capsules comprise a capsule wall, said capsule wall comprising wall material selected from the group consisting of melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof, preferably the capsule wall comprises one or more wall material comprising melamine, polyacrylate based material and combinations thereof.

14. A method for treating fabrics, said method comprising:
i) Storing the packaged product according to claim 1;
ii) Optionally washing, rinsing and/or drying said fabrics;
iii) Dosing the packaged product without rehomogenizing the liquid fabric softener composition according to claim 1, into a dosing cup or directly into the washing machine
iv) Contacting said fabrics with said liquid fabric softener composition in a washing and/or rinsing cycle.

15. A method of improving the phase stability of a liquid fabric softener composition, said method comprising packaging said liquid fabric softener composition in a package having a closed end and a peripheral wall extending from said closed end to an open neck, said peripheral wall having an interior surface comprising a material selected from the group consisting of polyethylene terephthalate, polypropylene, and mixtures thereof, said liquid fabric softening composition comprising a quaternary ammonium ester softening active at a level of from about 3% to about 25%, dispersed perfume at a level of from about 0.1% to about 5.0%, and cellulose fibers at a level of from about 0.01% to about 5.0%, by weight of said liquid fabric softener composition
